(19) United States
(12) Patent Application Publication
(10) Pub. No.: US 2011/0012373 A1
(43) Pub. Date: Jan. 20, 2011

(54) BOLT HAVING A LEVER-SHAPED BOLT DRIVE

(76) Inventor: Dieter Ramsauer, Schwelm (DE)

Correspondence Address: FROMMER LAWRENCE & HAUG, 745 FIFTH AVENUE- 10TH FL., NEW YORK, NY, 10151, US

(21) Appl. No.: 12/738,378

(22) PCT Filed: Dec. 8, 2007
(86) PCT No.: PCT/EP07/10699

§ 371 Date: Sep. 16, 2010

(30) Foreign Application Priority Data
Oct. 17, 2007 (DE) 20 2007 014 504.7

(51) Int. Cl. E05C 1/08

(52) U.S. Cl. 292/138

(57) ABSTRACT

A bar closure comprises a closure drive with a lever-shaped bar drive with at least one bar receptacle for a locking bar of the bar closure and with an optional rotary latch, wherein the bar receptacle is connected to the bar drive by means of an articulated arrangement. According to the invention, the bar receptacle has a clip device in which, or on which, the end of the bar can be inserted or fitted so as to catch.

The present application claims priority from PCT Patent Application No. PCT/EP2007/010669 filed on Dec. 8, 2007, which claims priority from German Patent Application No. DE 20 2007 014 504.7 filed on Oct. 17, 2007, the disclosure of which is incorporated herein by reference in its entirety.

### BACKGROUND OF THE INVENTION

1. Field of the Invention

The invention is directed to a bar closure comprising a closure drive with a lever-shaped bar drive with at least one bar receptacle for a locking bar of the bar closure and with an optional rotary latch, wherein the bar receptacle is connected to the bar drive by means of an articulated arrangement.

2. Description of Related Art

A bar closure of the type mentioned above is already known from European Patent 0054225. As can be seen from FIGS. 1 and 2 of the above-cited patent, the bar closure disclosed therein comprises a door leaf fitting which has a bearing support for a drive shaft, a rotary latch being arranged on this bearing support. The rotary latch has two oppositely arranged arms which carry two bearing pins to which is fitted a round bar provided with an opening at its end. A retaining ring prevents sliding off so that when the sash-type latch is rotated into the fastening position shown in FIG. 2 the bars are pushed outward and, in so doing, engage back-engagement surfaces formed, for example, by the door frame, thereby securing the door leaf to this door frame.

### SUMMARY OF THE INVENTION

The production and mounting of the closure in the above-cited patent is not optimal for certain applications. It is the object of the invention to provide an improved design which, in particular, facilitates mounting and which can also be produced in a simpler manner.

The above-stated object is met in that the bar receptacle has a clip device in which, or on which, the end of the bar can be inserted or fitted so as to catch.

By means of this catching, the bar is automatically secured in the bar receptacle so that a retaining ring for the same purpose need not be provided. In many applications, it is sufficient when the bar receptacle and bar drive are injection molded from plastic because plastics with great inherent strength are currently commercially available and the closing forces which can be achieved thereby are sufficient.

An embodiment example in which the articulated arrangement is formed by a film hinge is possible with the plastic material mentioned above.

This has the advantage that the bar drive and the bar receptacles can be injection molded integral with one another, which simplifies production enormously.

Alternatively, the bar receptacle can be made of plastic and the bar drive can be made of metal. In this case, an advisable arrangement consists in that the articulated arrangement is formed by a metal pin which is formed or carried by the bar drive and which can be engaged in a clip-like manner by an axially slit hinge roller which is formed or carried by the bar receptacle.

The hinge roller can be slit in a position extending perpendicular to the bar axis. Alternatively, the hinge roller can also be slit in a position lying in the bar axis.

The hinge roller advantageously forms, at the end of the slit, an axial stop for the pin because the possibility of losing the pin can be eliminated in this way.

An intermediate position (rotated by 45 degrees with respect to the bar axis) is also possible.

The articulated arrangement can comprise a connection part of flexible plastic or rubber which can be received by clipping into a slit eyelet of the bar drive on one side and into a slit eyelet of the bar receptacle on the other side.

According to another embodiment form, the articulated arrangement comprises a stud which is provided with an annular groove and which proceeds from the lever end of the lever-shaped bar drive, a bar receptacle part provided with an eyelet can be fitted to this stud and can be prevented from sliding off by spring legs which proceed from the eyelet and project into the annular groove. Mounting can be carried out faster in this way.

According to another embodiment form, the spring legs are formed by a metal sleeve whose front edge has a plurality of notches to form the spring legs.

Alternatively, according to another embodiment form, the spring legs can be spring legs which are formed integral with the injection-molded plastic eyelet.

According to another embodiment form, the bar receptacle part forms a hollow space in which the free end of a rectangular bar can be inserted, this rectangular bar being provided at its end with an opening or recess in which a spring leg projecting into the hollow space can be received so as to lock the bar.

Alternatively, according to another embodiment form, the bar receptacle part forms a hollow space in which the free end of a round bar can be inserted, which end can be received in a locking manner by a flat spring disk which is provided with an opening and which projects into the hollow space. In this case (claim 16), the bar receptacle part can have a lateral slit for the insertion of the flat spring disk.

On the other hand, according to another embodiment form, the bar receptacle part can be injection molded from plastic, and the flat spring disk can be surrounded by this plastic.

As in the prior art, the bar drive can form a double-lever, and a bar receptacle according to the invention can be arranged at both of its ends.

The bar drive can have a receptacle for a separately insertable, conventional latch tongue. This is already known, per se (see, for example, page 2-151 of a catalog by DIRAK GmbH & Co. KG, Königsfelder Str. 1, DE-58256, Ennepetal, Germany, entitled “Modular Hardware Systems DIRAK—Handbuch 2007 Deutsch”. On the other hand, an embodiment form in which the bar drive has a latch tongue that is produced integral with it is conceivable.

The articulated arrangement can project over the bar drive and/or bar receptacle on at least one side, preferably on the side directed to the fastening surface for the closure, resulting in a greater extension for the film hinge and, therefore, greater strength. Further, a desired distance is maintained with respect to the fastening surface, for example, a door leaf.

The bar drive can have a bar receptacle for a round bar with an eyelet or opening at the end. Alternatively, the bar drive can also have a bar receptacle for a flat bar with an eyelet or opening at the end.

### BRIEF DESCRIPTION OF THE DRAWINGS

FIG. 1A shows an exploded view of an embodiment form made from plastic with film hinges for receiving two round bars;

FIG. 1B shows a perspective view of the arrangement according to FIG. 1A after insertion of the bars;

FIG. 2A shows a view corresponding to FIG. 1A of an embodiment form for flat bars;

FIG. 2B shows a corresponding view of the arrangement after fitting the flat bars;

FIG. 3A shows a perspective view of the three parts of an embodiment form made of metal and plastic;

FIG. 3B shows a top view of the arrangement according to FIG. 3A;

FIG. 3C shows the assembled arrangement in the closed position with bar receptacles pushed apart;

FIG. 3D shows a corresponding view of the position with the bars pulled in;

FIGS. 4A and 4B, and FIGS. 5A and 5B show corresponding views of additional embodiment forms;

FIGS. 6A and 6B show corresponding views of an additional embodiment form;

FIG. 6C shows an axial sectional view;

FIG. 6D shows a top view;

FIG. 7A shows an exploded view of a first embodiment form and an additional embodiment form made of plastic with film hinges for receiving round bars (right-hand side of drawing) or flat bars (left-hand side of drawing);

FIG. 7B shows a perspective view of the arrangement according to FIG. 7A after insertion of the bars;

FIGS. 8A and 8B show a top view and a sectional view of details of the round bar receptacle;

FIGS. 9A and 9B show corresponding views of details of the receptacle for flat rectangular bars;

FIGS. 9C and 9D show corresponding views, but rotated by 90 degrees; and

FIGS. 9E and 9F show a perspective view and an exploded view of the receptacle for flat bars.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

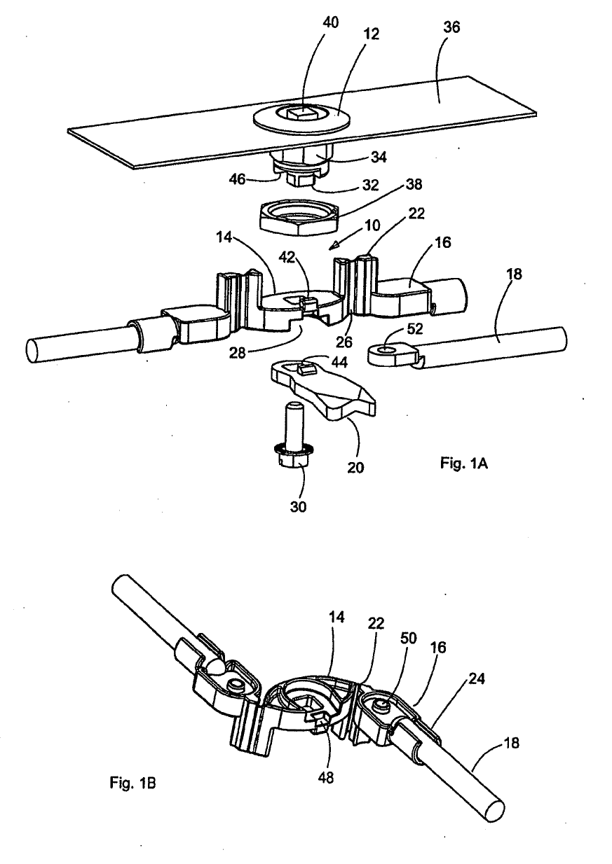

FIG. 1 shows an exploded view of the drive area of a bar closure 10 comprising a closure drive 12 with a lever-shaped bar drive 14 and with at least one, in this case two, bar receptacles 16 for a locking bar 18 of the bar closure 10 and with an optional rotary latch 20, wherein the bar receptacle 16 is connected to the bar drive 14 by an articulated arrangement 22. As is shown in FIG. 1B, the bar receptacle 16 has a clip device 24. In the embodiment form shown in FIGS. 1A and 1B, the bar receptacle 16 and the bar drive 14 are injection molded from plastic. This makes it possible to realize the articulated arrangement by means of a film hinge 26 in which the flexibility of the hinge is made possible by a thin connecting film.

The tongue or the rotary latch 20 can be injection molded integral with the bar drive 14, but in this case is shown as a separate part 20 which can be received by positive engagement in a corresponding recess 28 of the bar drive 14 and secured by a screw 30 which can be screwed into a drive shaft 32 at the front by means of a corresponding threaded bore hole. The drive shaft 32 is rotatable (e.g., by 90°) in a closure housing 34 which can be mounted in turn in a thin wall such as a sheet metal cabinet door 36, for example, by means of a union nut 38. The drive shaft 32 has a square end on which a square opening of the bar drive 14 can be inserted. In a corresponding manner, a tongue 20 is provided with a square opening by which the sash-type tongue 20 can be fitted to the shaft 32 so as to be rigid with respect to rotation relative to it and is then held in position by the nut 30. The drive shaft 32 is driven, for example, by a socket wrench which can be applied to the other end 40 of the drive shaft 32 from the outside.

The bar drive 14 has a nose 42 which, instead of the nose 44 of the rotary latch 20, engages with a corresponding recess surface 46 of the housing end 34 and limits the rotational path of the bar drive 14 (e.g., to 90 degrees).

The nose 44 of the tongue 20 is received by a corresponding recess 48 in the drive disk 14.

The round bar 18 is secured axially by a pin or projection 50 which is guided through a corresponding opening in the pressed-flat end of the round bar 18 when the round bar 18 is in the clipped-in position shown in FIG. 1B.

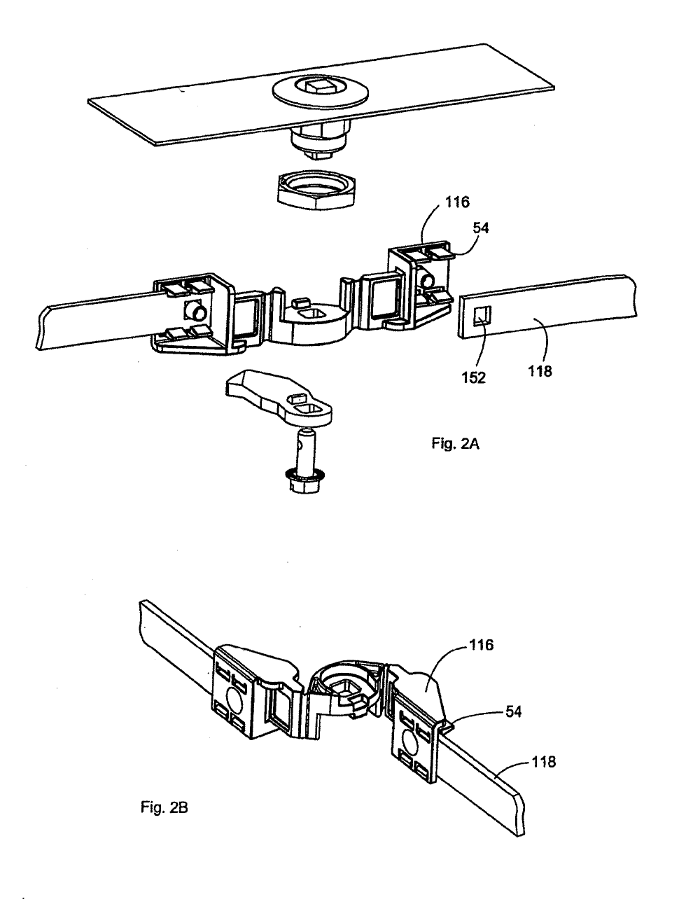

FIGS. 2A and 2B show a construction which is similar to that of FIGS. 1A and 1B, but is provided for flat bars 118. In this case, four noses 54 hold the ribbon bar 118 in the holder or receptacle 116.

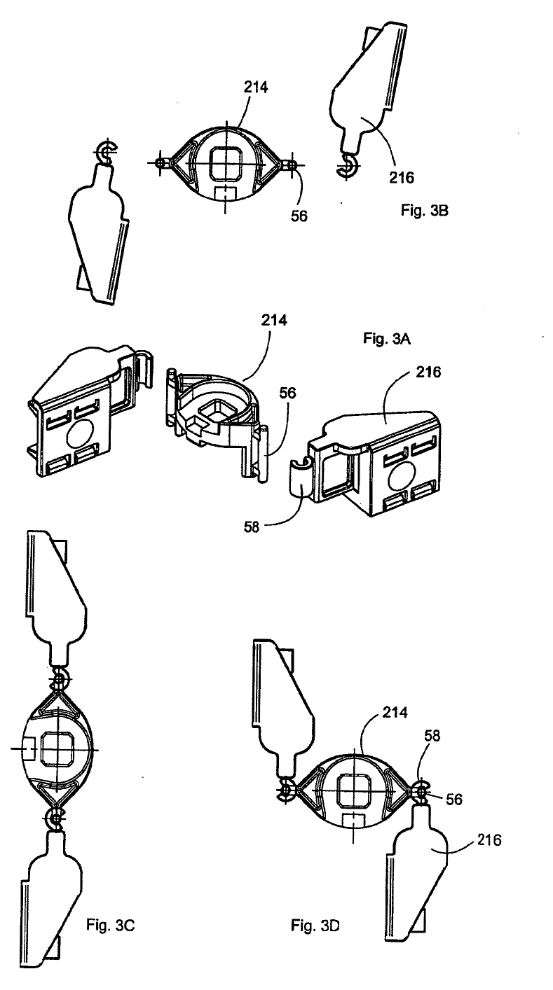

In the embodiment form according to FIGS. 3A and 3B, the bar receptacle 216 is made of plastic, while the bar drive 214 is made of metal. The bar drive 214 comprises a metal pin 56 which can be grasped in a clip-like manner by an axially slit hinge roller which is formed or carried by the bar receptacle.

FIGS. 3C and 3D show the mounted position. FIG. 3C shows the position in which the two locking bars, not shown, are pushed apart, while FIG. 3D shows the position in which the bar drive 214 is in the other position in which the two bars are pulled together.

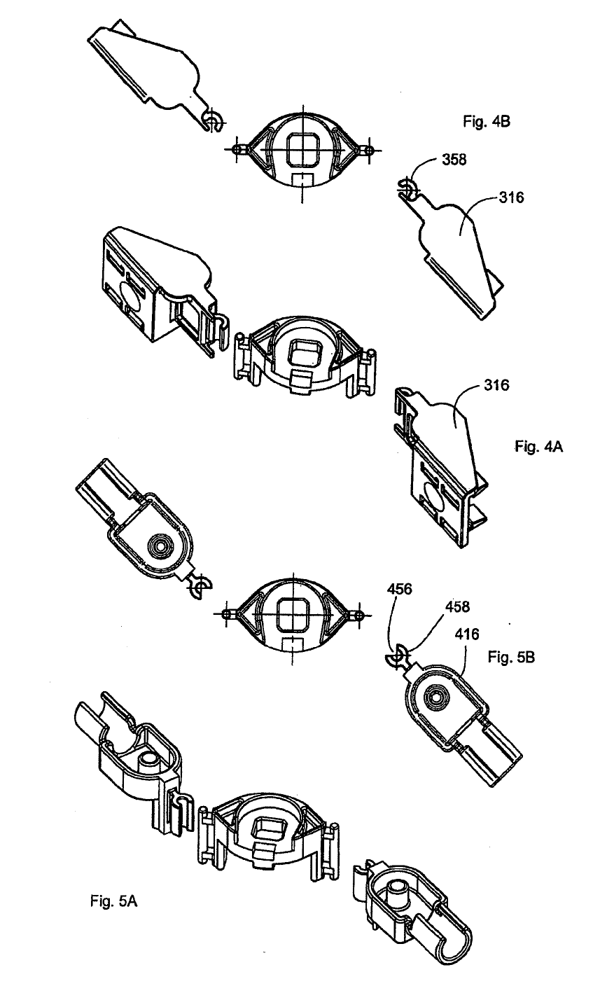

FIGS. 4A and 4B show an embodiment form which is similar to FIGS. 3A to 3D, but in which the hinge roller 358 is shaped differently. While the hinge roller 58 is slit in a position perpendicular to the bar axis in the embodiment form according to FIGS. 3A to 3D, the position shown in FIGS. 4A and 4B is displaced by 45 degrees. In FIGS. 5A and 5B, the hinge roller 458 extends in such a way that it is slit in a position lying in the bar axis.

The embodiment forms according to FIGS. 2A, 2B, FIGS. 3A to 3D and FIGS. 4A to 4D are suitable for flat bars 118, while FIGS. 5A and 5B show an embodiment form which is suitable for round bars. In this case, however, the bar receptacles 16, 116, 216, 316, 416 are injection molded from plastic.

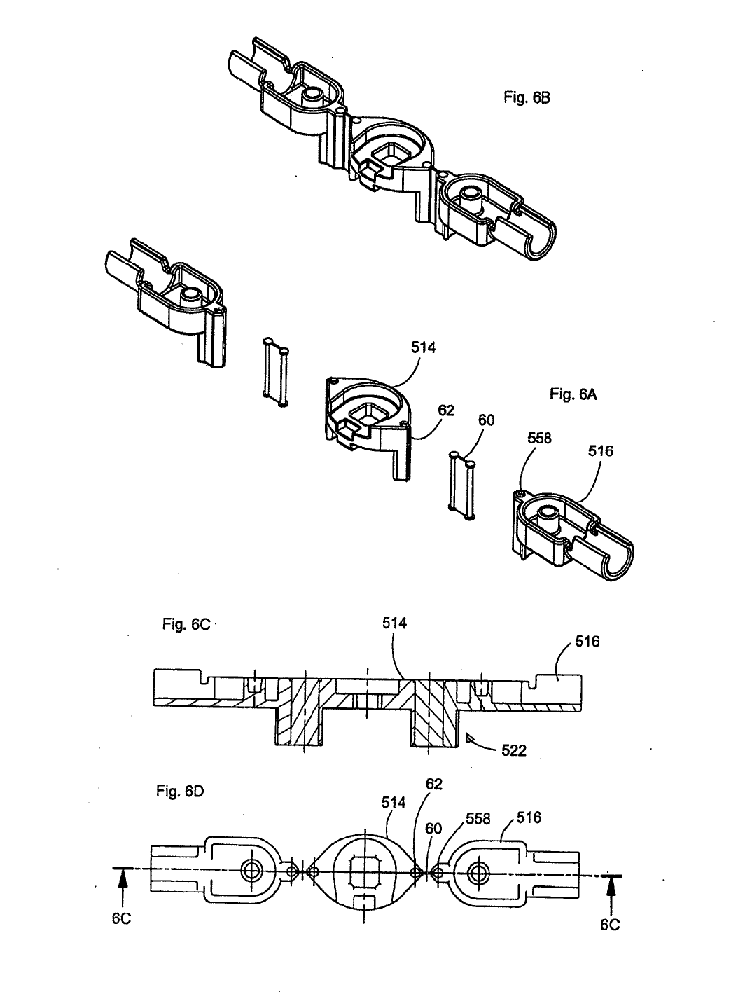

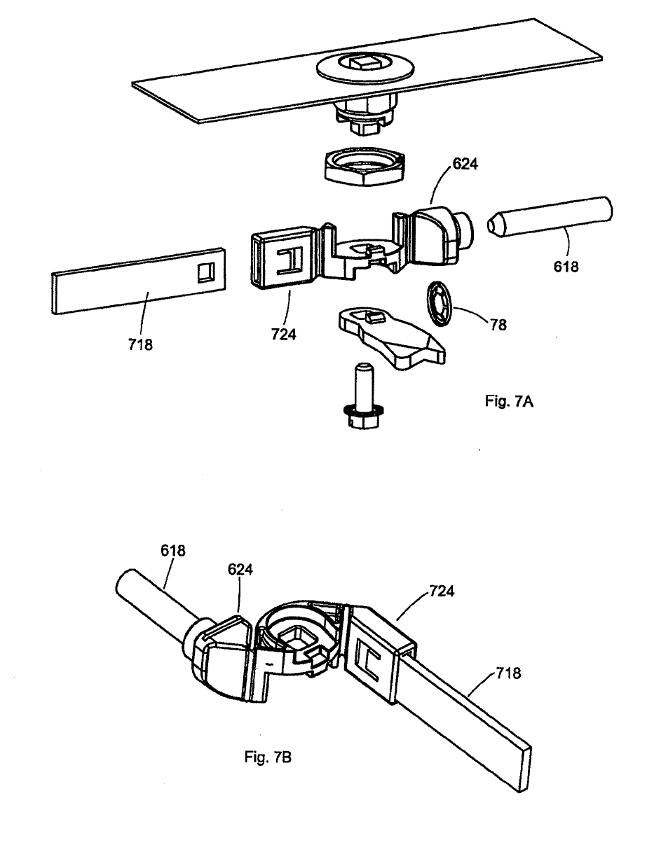

FIGS. 6A and 6B show an embodiment form in which the drive 514 is made of metal and the bar receptacle 516 is made of plastic. The articulated arrangement 522 comprises a connection part 60 of flexible plastic or rubber which can be clipped into a slit eyelet 558 of the bar receptacle 516 on one side and into a correspondingly slit eyelet 62 of the bar drive 514 on the other side.

FIG. 6D shows a top view of the embodiment form in the assembled state, while FIG. 6C shows a sectional view along section line 6C-6C of FIG. 6D.

In all of the embodiment forms, the articulated arrangement 22, 522 projects over the bar drive 14, 514 and/or the bar receptacle 16, 516 on at least one side, preferably on the side facing the fastening surface 36.

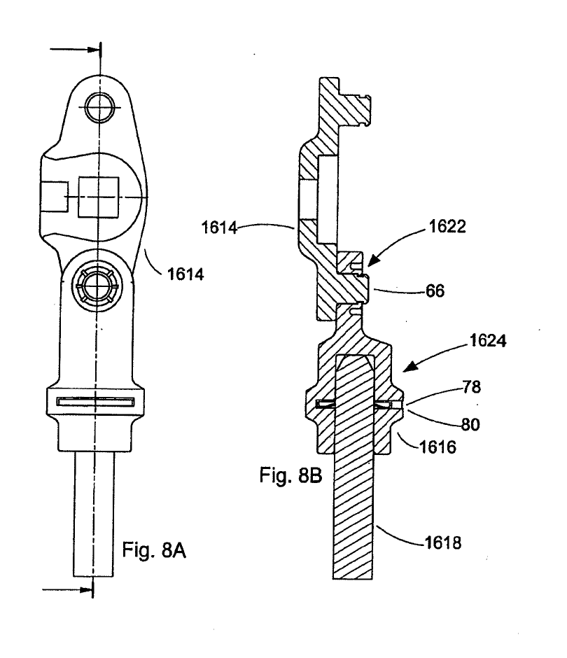

FIG. 7A is an exploded view showing a first embodiment form and another embodiment form made of plastic with film hinges for receiving round bars (right-hand side of the drawing) or flat bars (left-hand side of the drawing), while FIG. 7B is a perspective view showing the arrangement according to FIG. 7A after insertion of the bars. FIGS. 8A and 8B show a top view and a sectional view of details of the round bar receptacle.

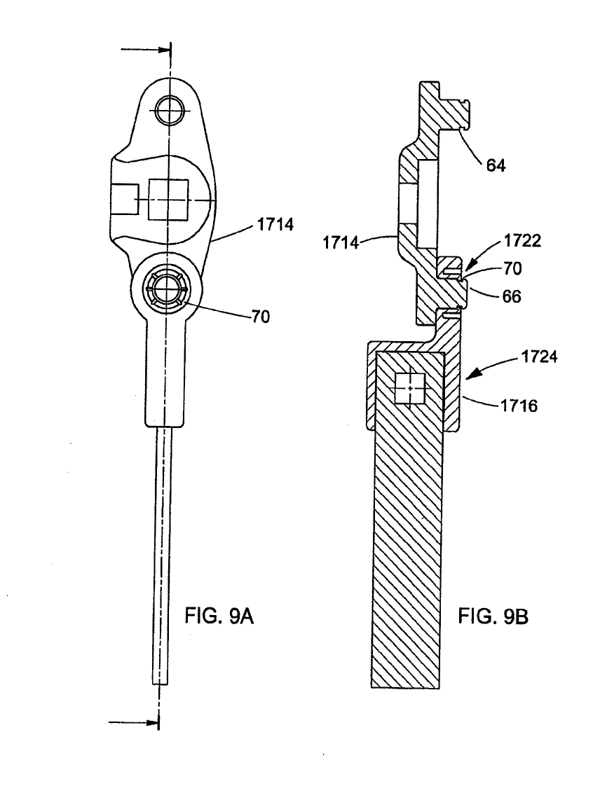

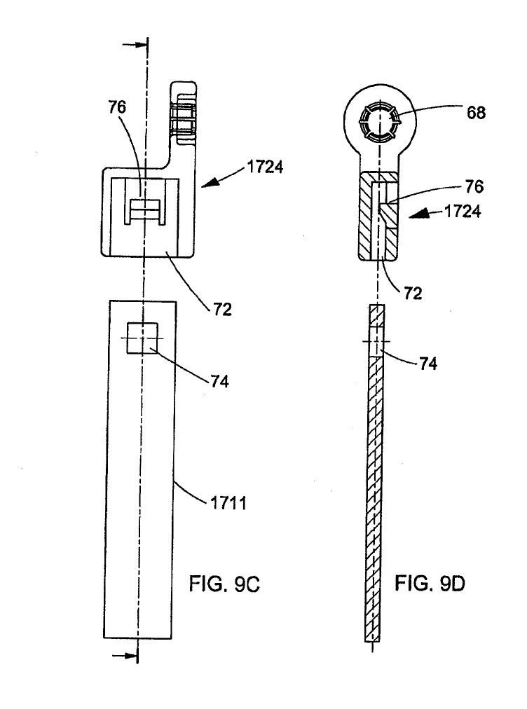

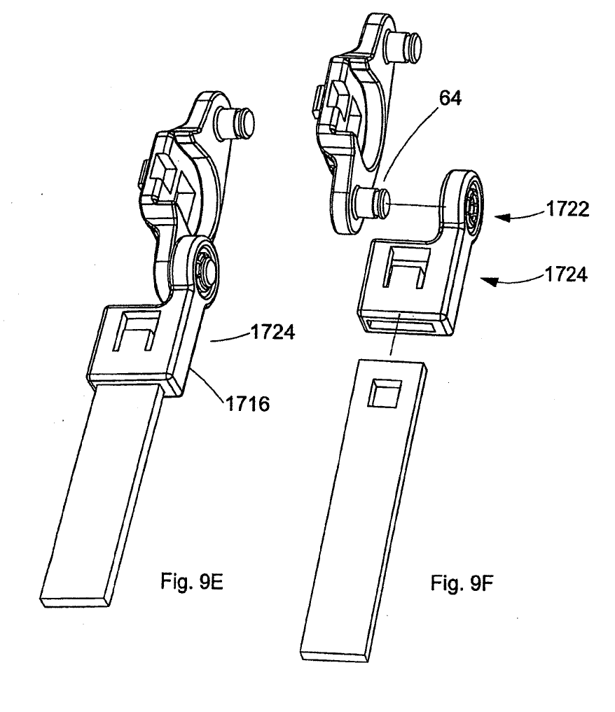

According to the other embodiment form in FIGS. 8A to 9F, the articulated arrangement 1622, 1722 comprises a stud 66 which is provided with an annular groove 64 and which proceeds from the lever end of the lever-shaped bar drive 1614, 1714. A bar receptacle part 1616, 1716 provided with eyelet 68 can be fitted to the stud 66 and is prevented from sliding off by spring legs 70 which proceed from the eyelet 68 and project into the annular groove 64. Mounting can be carried out faster in this way.

The spring legs 70 can be formed by a metal sleeve, one of whose front edges has a plurality of notches to form the spring legs.

Alternatively, the spring legs 70 can be spring legs emerging from a plastic injection-molded eyelet 68 so as to be integral therewith.

According to FIGS. 9A to 9F, the bar receptacle part 1716 forms a hollow space 72 in which the free end of a rectangular bar 1711 can be inserted, this rectangular bar 1711 being provided at its end with an opening 74 or recess in which a spring leg 76 projecting into the hollow space 72 can be received so as to lock the bar 1711.

Alternatively, according to FIGS. 8A and 8B, the bar receptacle part 1616 forms a hollow space in which the free end of a round bar 1618 can be inserted, which end can be received in a locking manner by a flat spring disk 78 (see also FIG. 7A) which is provided with an opening and which projects into the hollow space. In this case, the bar receptacle part 1616 can have a lateral slit 80 for the insertion of the flat spring disk 78.

On the other hand, the bar receptacle part (particularly if it should be injection molded from plastic) can be constructed in such a way that the flat spring disk is surrounded by this plastic and, as such, fixedly anchored therein.

The advantage of the embodiment form for round bars consists in that the bar requires no special shape at the end such as a pressed-flat end, for example, according to FIG. 1A, with an opening (i.e., the bar can be shortened in place).

Commercial Applicability:

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS:

10 closure

12 closure drive

14, 214, 514, 1614, 1724 bar drive

16, 116, 216, 516, 1616, 1716 bar receptacle

18, 118 bar

20 rotary latch, tongue

22, 522, 1622 articulated arrangement

24, 1624, 1724 clip device

26 thin film, film hinge

28 recess

30 screw

32 drive shaft

34 closure housing

36 wall, fastening surface

38 union nut

40 other end

42 nose

44 nose

46 recess

48 recess

50 pin, projection

52 opening

54 nose

56 metal pin

58, 358, 458, 558 hinge roller, eyelet

60 connection part

62 slit eyelet

64 annular groove

66 stud

68 eyelet

70 spring legs

72 hollow space

74 opening

76 spring leg

78 flat spring disk

80 slit

1. Bar closure comprising a closure drive (12) with a lever-shaped bar drive (14) (14) with at least one bar receptacle (16) for a locking bar (18) of the bar closure (10) and with an optional rotary latch (20), wherein the bar receptacle (16) is connected to the bar drive (14) by means of an articulated arrangement (22), characterized in that the bar receptacle (16) has a clip device (24) in which, or on which, the end of the bar (18) can be inserted or fitted so as to catch.

2. Bar closure according to claim 1, characterized in that the bar receptacle (16) and bar drive (14) are injection molded from plastic.

3. Bar closure according to claim 2, characterized in that the articulated arrangement (22) is formed by a film hinge (26).

4. Bar closure according to claim 1, characterized in that the bar receptacle (16) is made of plastic and the bar drive (14) is made of metal.

5. Bar closure according to claim 4, characterized in that the articulated arrangement (22) is formed by a metal pin (56) which is formed or carried by the bar drive (214) and which can be engaged in a clip-like manner by an axially slit hinge roller (58, 358, 458) which is formed or carried by the bar receptacle (216, 316, 416).

6. Bar closure according to claim 5, characterized in that the hinge roller (58) is slit in a position which is offset by 45 degrees relative to the bar axis.

7. Bar closure according to claim 5, characterized in that the hinge roller (358) is slit in a position perpendicular to the bar axis.

8. Bar closure according to claim 5, characterized in that in that the hinge roller (458) is slit in a position lying in the bar axis.

9. Bar closure according to claim 6, 7 or 8, characterized in that the hinge roller forms, at the end of the slit, an axial stop for the pin.

10. Bar closure according to claim 2, characterized in that the articulated arrangement (22) comprises a connection part (60) of flexible plastic or rubber which can be received by clipping into a slit eyelet (62) of the bar drive (514) on one side and into a slit eyelet (558) of the bar receptacle (516) on the other side.

11. Bar closure according to claim 1, characterized in that the articulated arrangement (1622) comprises a stud which is provided with an annular groove and which proceeds from the lever end of the lever-shaped bar drive, and a bar receptacle part provided with an eyelet can be fitted thereto and prevented from sliding off by spring legs which proceed from the eyelet and project into the annular groove.

12. Bar closure according to claim 11, characterized in that the spring leg is formed by a metal sleeve whose front edge has a plurality of notches to form the spring legs.

13. Bar closure according to claim 11, characterized in that the spring legs are spring legs which are formed integral with the injection-molded plastic eyelet.

14. Bar closure according to claim 11, 12 or 13, characterized in that the bar receptacle part (1716) forms a hollow space in which the free end of a rectangular bar can be inserted, this rectangular bar being provided at its end with an opening or recess in which a spring leg projecting into the hollow space can be received so as to lock the bar.

15. Bar closure according to claim 11, 12 or 13, characterized in that the bar receptacle part (1616) forms a hollow space in which the free end of a round bar can be inserted, which end can be received in a locking manner by a flat spring disk which is provided with an opening and which projects into the hollow space.

16. Bar closure according to claim 15, characterized in that the bar receptacle part has a lateral slit for the insertion of the flat spring disk.

17. Bar closure according to claim 15, characterized in that the bar receptacle part is injection molded from plastic, and the flat spring disk is surrounded by this plastic.

18. Bar closure according to one of claims 1 to 17, characterized in that the bar drive (14) forms a double-lever, and a bar receptacle (16) is arranged at both of its ends.

19. Bar closure according to one of claims 1 to 12, characterized in that the bar drive (14) has a receptacle (28) for a separately insertable, conventional latch tongue (20).

20. Bar closure according to one of claims 1 to 18, characterized in that the bar drive has a latch tongue that is produced integral with it.

21. Bar closure according to one of claims 1 to 20, characterized in that the articulated arrangement (22, 522, 1722) projects over the bar drive (14, 514) and/or the bar receptacle (16, 516, 1716) on at least one side, preferably on the side directed to the fastening surface (36) for the closure (10).

22. Bar closure according to one of claims 1 to 14, characterized in that the bar drive (14, 514) has a bar receptacle (16, 516) for a round bar (18) with an eyelet or opening (52) at the end.

23. Bar closure according to one of claims 1 to 14, characterized in that the bar drive has a bar receptacle (116) for a flat bar (118) with an eyelet or opening (152) at the end.
